(19) United States
(12) Patent Application Publication
(10) Pub. No.: US 2024/0159867 A1
(43) Pub. Date: May 16, 2024

(54) DETECT WEATHER CHANGES VIA GROUND PLANE REFLECTION COEFFICIENTS

(71) Applicant: Telefonaktiebolaget LM Ericsson (publ), Stockholm (SE)

(72) Inventors: Peter ÖKVIST, Luleå (SE); Arne SIMONSSON, Gammelstad (SE); Henrik ASPLUND, Stockholm (SE); Medhat MOHAMAD, Kista (SE)

(21) Appl. No.: 18/550,003

(22) PCT Filed: Mar. 15, 2021
(86) PCT No.: PCT/SE2021/050226

§ 371 Date: Sep. 11, 2023

(51) Int. Cl. G01S 7/41; G01S 7/00

(52) U.S. Cl. CPC G01S 7/41; G01S 7/006

(57) ABSTRACT

The present disclosure relates to a method a radio base station of determining a current characteristic of a surface, and a radio base station performing the method. In an aspect, a method a radio base station of determining a current characteristic of a surface is provided. The method comprises determining a value of at least one energy property of a signal received from a wireless communication device, which signal has reflected against the surface before arriving at the radio base station, and determining, based on one or more observed signal energy property values each being associated with a characteristic of the surface, the current characteristic of the surface for the determined value of the at least one energy property of the received signal.

### TECHNICAL FIELD

The present disclosure relates to a method a radio base station of determining a current characteristic of a surface, and a radio base station performing the method.

### BACKGROUND

In the art, weather forecast solutions typically require own dedicated infrastructure adding cost and need for maintenance. These are commonly installed at radio towers where installation space in radio towers is also typically scarce.

For instance, humidity sensors may be installed at the radio towers in order to determine precipitation at a radio site. This requires specialized sensors occasionally in need of maintenance.

Thus, alternative weather forecast solutions are desired.

### SUMMARY

One objective is to solve, or at least mitigate, this problem in the art and to provide a method a radio base station of determining a current characteristic of a surface.

This objective is attained in a first aspect by a method a radio base station of determining a current characteristic of a surface. The method comprises determining a value of at least one energy property of a signal received from a wireless communication device, which signal has reflected against said surface before arriving at the radio base station and determining, based on one or more observed signal energy property values each being associated with a characteristic of said surface, the current characteristic of said surface for the determined value of said at least one energy property of the received signal.

This objective is attained in a second aspect by a radio base station configured to determine a current characteristic of a surface. The radio base station comprises a processing unit and a memory, said memory containing instructions executable by said processing unit, whereby the radio base station is operative to determine a value of at least one energy property of a signal received from a wireless communication device, which signal has reflected against said surface before arriving at the radio base station and to determine, based on one or more observed signal energy property values each being associated with a characteristic of said surface, the current characteristic of said surface for the determined value of said at least one energy property of the received signal.

Advantageously, the radio base station determines a value of an energy property of the received signal, for instance energy content. By previously having observed signals reflected off of different types of surfaces and recorded energy content values for these signals, it is possible for the radio base station to determine—from the value of the current received signal—which type of surface the current signal has reflected against.

In an embodiment, a look-up table approach is employed comprising comparing the determined value of said at least one energy property with said one or more observed signal energy property values, each value being associated with a characteristic of said surface. The determining of the current characteristic of said surface further comprises selecting as the current characteristic of said surface the particular characteristic associated with the observed signal energy property value to which the determined value of said at least one energy property is considered to best correspond.

In an embodiment, a database is created comprising said one or more observed signal energy property values by recording at least one signal energy property value and a characteristic of the surface against which the signal is reflected for one or more wireless communication devices at different positions and/or for different direction-of-arrivals of the reflected signal being received at the radio base station. The selecting as the current characteristic of said surface further comprises selecting, from the database, the surface characteristic corresponding to a current position of the wireless communication device and/or a current direction-of-arrival of the reflected signal being received at the radio base station, and to the value of said at least one energy property of the signal received for the wireless communication device.

In an embodiment, a machine learning (ML) approach is employed acquiring an ML model having been trained with observed values of said at least one energy property of signals received from a wireless communication device, position of the wireless communication device when transmitting each signal and/or direction-of-arrival of each reflected signal being received at the radio base station, and the characteristic of the surface against which each signal is reflected. Thereafter, the determined value of said at least one energy property for the received signal and a current position of the wireless communication device and/or a current direction-of-arrival of the reflected signal being received at the radio base station is supplied to the acquired trained ML model, the trained ML model estimating for said position and/or direction-of-arrival, using a relationship between said at least one energy property for the received signal and the characteristic of the surface, which surface characteristic the determined value of said at least one energy property energy property represents. The determining of the current characteristic of said surface further comprises selecting as the current characteristic of said surface the surface characteristic being output by the trained ML model.

In an embodiment, a signal being received within a predetermined time period from a firstly received direct-path signal of the wireless communication device is considered to be as signal reflected against said surface before arriving at the radio base station.

In an embodiment, the determined characteristic indicates a reflectivity metric of the surface from which a constitution of the surface can be identified.

In an embodiment, a reflectivity metric exceeding a predetermined first threshold value indicates that the surface is wet, while a reflectivity metric being below a predetermined lower second threshold value indicates that the surface is dry.

In an embodiment, the energy property of the received signal comprises one or more of energy content of the received signal, degree of polarization of the received signal in a horizontal direction, vertical direction, or both, and difference in received energy between two different polarizations.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a radio base station deployment according to an embodiment;

FIG. 2 shows a flowchart illustrating a method of the radio base station of determining a current characteristic of a surface according to an embodiment

FIG. 3 shows a flowchart illustrating a method of the radio base station of determining a current characteristic of a surface according to an embodiment;

FIG. 4 illustrates signals being transmitted by a wireless communication device from three different positions for recording at the radio base station according to an embodiment;

FIG. 5a illustrating training of a machine learning model according to an embodiment;

FIG. 5b illustrating utilization of the trained machine learning model to determine a characteristic of a surface against according to an embodiment;

FIG. 6 illustrates a flowchart of a method of the radio base station of determining a current characteristic of a surface according to an embodiment; and

FIG. 7 illustrates a radio base station according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

When a radio wave is reflected against an intersection between two different dielectric medias, different portions the wave energy is reflected against the intersection depending on various characteristics of the two medias.

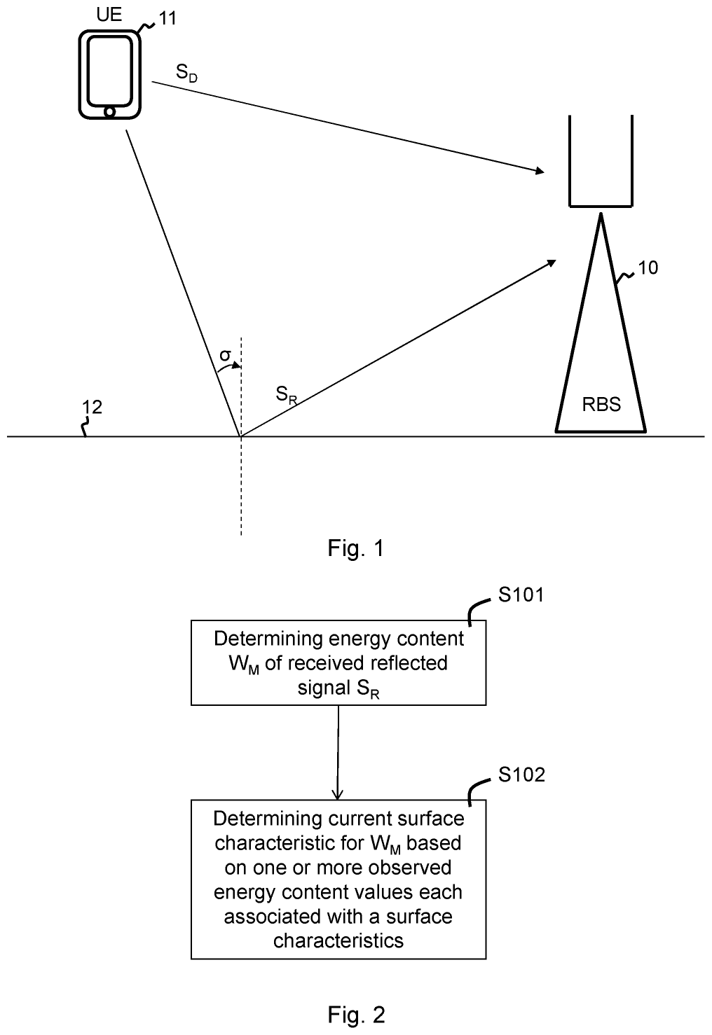

FIG. 1 illustrates an embodiment where a radio base station 10 (RBS) takes advantage of this notion. Reference is further made to FIG. 2 showing a flowchart illustrating a method the RBS 10 of determining a current characteristic of a surface 12 according to an embodiment.

Thus, a wireless communication device ii, commonly referred to as User Equipment (UE), communicates with the RBS 10 and upon transmitting radio signals (i.e. radio waves) some signals SD may be traverse directly from the UE 11 while other signals S_{R} may reflect against a ground surface 12 before being received at the RBS 10.

Now, upon the RBS 10 receiving the reflected signal S_{R}, the RBS 10 determines in step S101 one or more energy properties of the received signal S_{R}. In one embodiment, the RBS 10 determines or measures an energy content W_{M} of the received signal S_{R}.

In a next step S102, previously observed signal energy values each associated with a particular ground surface characteristic are utilized to determine a particular characteristic of the surface 12 against which the current signal S_{R} is reflected. Thus, one signal energy value may indicate one particular surface characteristic while another signal energy value may indicate another (even though two similar values may indicate the same surface characteristic).

As will be discussed in detail in the following with reference to various embodiments, there are different ways of performing the determining in step S102 of a particular surface characteristic associated with a value of an energy property of a received signal S_{R} reflected against the surface 12. For instance, in a one embodiment a look-up table is employed while in another embodiment a trained machine learning (ML) model is utilized, both embodiments utilizing previously observed signal values associated with various surface characteristics.

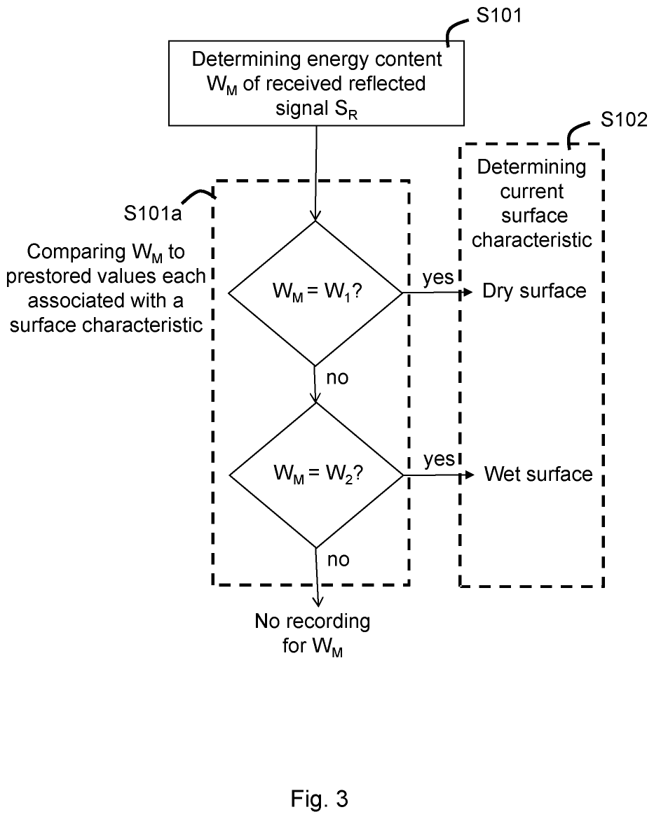

Reference is further made to FIG. 3 showing a flowchart illustrating a method the RBS 10 of determining a current characteristic of a surface 12 according to an embodiment employing a look-up table.

Again, the UE 11 transmits radio signals at least one of which (i.e. signal S_{R}) reflects against the ground surface 12 before being received at the RBS 10. Upon the RBS 10 receiving the reflected signal S_{R}, the RBS 10 determines in step S101 one or more energy properties of the received signal S_{R}. In this exemplifying embodiment, the RBS 10 determines or measures an energy content W_{M} of the received signal S_{R}.

Thereafter, the RBS 10 turns to a database comprising one or more prestored signal energy values having been observed for a plurality of received reflected signals.

In a scenario where the ground surface 12 is dry, the reflectivity of the surface 12 is lower as compared to a situation where the surface 12 is wet.

Thus, the energy content of the signal S R received the RBS 10 will be lower if the ground surface 12 is dry as compared to if the ground surface 12 is wet.

The RBS 10 will in step S101a compare the measured energy content of the received signal S_{R} with one or more of the prestored signal energy values.

Assuming for instance that a prestored energy content value W₁ corresponds to a dry surface 12 while a prestored energy content value W₂ corresponds to a wet surface 12. It is understood that W₁ and W₂ each may represent a range of energy content values where the range W₂ is the higher of the two ranges.

If in the comparison performed in step S101a the RBS 10 concludes that the measured energy content W_{M} for the received signal S_{R} is close to W₂ (i.e. W_{M} is considered to best correspond with W₂ of the prestored values), the RBS 10 determines in step S102 that the surface 12 is wet while if the measured energy content W_{M} for the received signal S_{R} is close to W₁, the RBS 10 determines in step S103 that the surface 12 is dry. In the case prestored values W₁ and W₂ represent energy content ranges, the measured energy content value W_{M} is considered to best correspond to the one of the two ranges W₁ and W₂ which the value W_{M} falls within, and the associated surface characteristic is selected to represent the current surface character.

If no match is found, the RBS 10 may conclude that there is no surface type recorded and prestored for the measured value W_{M}. However, it is understood that W₁ and W₂ may be selected broadly such that W_{M} in practice will correspond to either one of the two.

In another example, an appropriately selected energy threshold value T_{W} is utilized where the surface 12 is determined to be wet if W_{M}>T_{W}. In other words, the result of the comparison in step S101a will indicate a current characteristic of the ground surface 12. As is noted, this will change over time where sometimes the surface 12 is wet while at other occasions the surface 12 is dry.

Advantageously, with this embodiment, the RBS 10 may determine with high accuracy whether the ground surface 12 is wet or dry and hance act as a weather forecast station. As is understood, the RBS 10 may even determine a degree of dryness/wetness of the surface 12 depending on the amount of energy reflected in the signal S_{R}, such as, dry, moist, wet, soaked.

Weather forecast solutions typically require own dedicated infrastructure; adding cost and need for maintenance. Installation space in radio towers is also typically scarce. Utilizing existing communication eco-systems and deployed equipment for other tasks in addition to communications purposes is thus highly advantageous.

As previously mentioned, when a radio wave is incident on a surface, different portions of the wave energy is reflected depending on the characteristics of the surface. In a further embodiment, polarization of the received signal is taken into account rather than the energy content of the signal.

How much of the energy that is being reflected typically depends on wave polarization and its angle of incidence at the surface, as well as the particular materials forming the intersection. The impact of the material is dependent on the dielectrics εr of the two materials forming the intersection, their respective permeability μr and angle σ of incidence of the radio wave.

Assuming that a two-ray ground reflection model is used and both materials have equal permeability μr=1, that one material is air while the other is ground (having dielectric constant εr) and that the angle of incidence of the radio wave with the ground is σ, the respective horizontal and vertical Fresnel reflection coefficients representing H and V polarization, respectively, may be expressed according to:

$$Γ ( H ) = \frac{sin σ - \sqrt{{ε}_{r} - {( cos σ )}^{2}}}{sin σ + \sqrt{{ε}_{r} - {( cos σ )}^{2}}} and Γ ( V ) = \frac{{ε}_{r} sin σ - \sqrt{{ε}_{r} - {( cos σ )}^{2}}}{{ε}_{r} sin σ + \sqrt{{ε}_{r} - {( cos σ )}^{2}}}$$

Table 1 below illustrates permeability εr of different materials commonly used for road coating, and for water which is commonly disposed on the road surface.

TABLE 1
Dielectric constant for different materials.

| Material | Dielectric constant (εr) |
|---|---|
| Air | 1 |
| Asphalt mix | 4-10 |
| Concrete | 5-9 |
| Aggregate | 6-18 |
| Water | 81 |

As is understood, while the dielectric constant for different road coatings typically is similar, there is a great difference between the dielectric constant of these road coatings and that of water, which has as an effect that changes in polarization of a radio signal being reflected against a ground surface will be evident in case of asphalt/concrete/aggregate versus water.

Further, as can be concluded from the above Fresnel reflection coefficients, a change in dielectric constant will have a greater impact on the horizontal polarization than on the vertical (since the sin σ component is multiplied with εr both in the nominator and the denominator and thus will “overshadow” the square root component). Hence, a change in the characteristics of the ground surface 12—such as from wet asphalt to dry asphalt or vice versa—will affect the polarization, and the RBS 10 will be able to determine the current characteristic of the ground surface 12 by comparing a measured polarization (either horizontal or vertical, or both) with one or more prestored polarization values associated with a particular ground surface type and conclude to which surface type the current measurement corresponds, similar to the approach described with reference to steps S102 and S103 in FIG. 2.

Advantageously, a road-side installed RBS 10 may detect the condition of a road and may even signal to the UE 11 (and thus its user) that the road is wet and that driving thus should be performed cautiously.

However, in practice, it may not always be easy to determine the characteristic of the ground surface 12 from a single measurement.

Therefore, regardless of whether the RBS 10 determines the surface characteristic of the ground from the energy content of the signal or the degree of H and/or V polarization of the signal as discussed hereinabove (or any other appropriate energy property of the signal received at the RBS 10) the RBS will in an embodiment be subjected to a great number of reflected signals, thereby creating a great number of observations in order to be able to associate a particular surface type with a certain energy property value as previously described.

Hence, in an embodiment, in order to create a database where a value of an energy property, such as polarization, of a signal received at the RBS 10 is associated with a particular ground surface characteristic, such that a current characteristic of the surface may be determined (cf. step S102) by comparing a currently measured polarization value with one or more of the prestored values in the database (cf. step S101a) to find a match, the RBS 10 must be subjected to a plurality of reflected signals from various UE positions and/or different direction-of-arrivals of the reflected signals S_{R} for each surface characteristic to be determined.

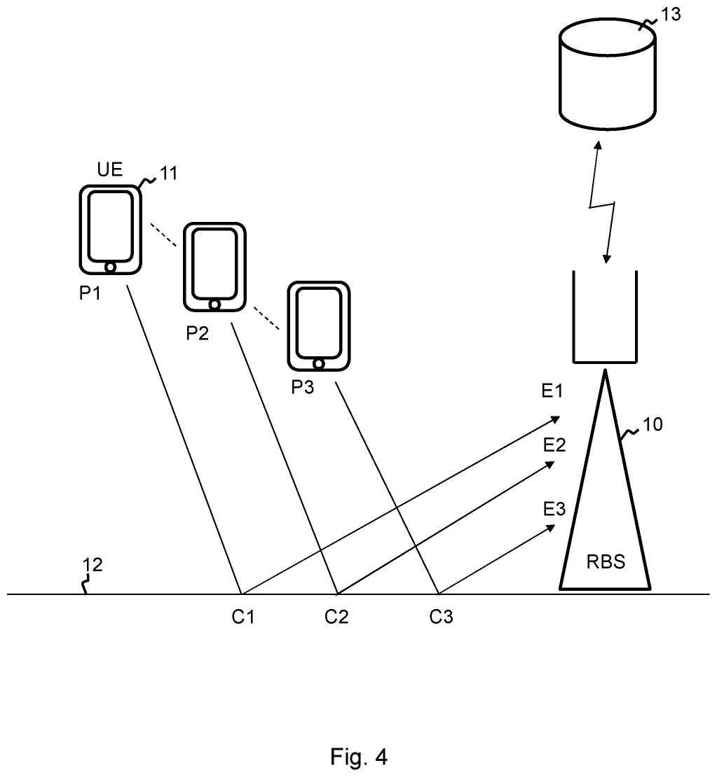

FIG. 4 illustrates signals being transmitted by a UE 11 (not necessarily by the same UE) from three different positions P1, P2 and P3. It is noted that in practice, hundreds or even thousands of signals received from different UE positions may be recorded by the RBS 10. The recording may further be aggregated over time increasing the number of positions. The positions may be represented by coordinates indicating longitude/latitude/altitude of the UE 11. For instance, the positions of the UE 11 may be obtained from e.g. the Global Positioning System (GPS). As mentioned, alternatively or additionally, direction-of-arrival of the received signals S_{R} may be determined. If the RBS 10 is equipped with multiple antennas, such as a MIMO (“Multiple Input Multiple Output”) antenna grid, the direction-of-arrival of the received signal S_{R} can be estimated.

The UE 11 may transmit with a random polarization depending on UE orientation and implemented antenna design. Typically, only one antenna is transmitting, but for uplink spatial multiplexing MIMO further antennas are used. Also, sounding reference signals (SRS) can be transmitted over two antennas, possibly in different time instances. For New Radio (NR) mm-wave, two antennas are commonly transmitting.

The RBS 10 may determine polarization of a received radio wave signal either in a horizontal direction, vertical direction, or both. Further, the difference between the received energy of horizontal and vertical polarizations can be determined, indicating the reflection characteristics of a surface.

Further shown is a server 13 in communication with the RBS 10. This may be a local server or an external remote server e.g. connected to the Internet, which may create and store the database.

When creating the database, a signal is received at the RBS 10 from the UE 11 being in position P1. The RBS 10 will thus determine an energy property value E1 of the received signal, for instance a value reflecting the horizontal (H) polarization of the received signal, for the position P1 (and/or for a particular direction-of-arrival of the received signal) as well as acquiring information indicating the associated characteristic C1 (“dry”) of the ground surface 12 against which the signal is reflected. As is understood, the information indicating the surface characteristic C1 may be manually provided to the RBS 10 by a system operator.

Thereafter, the UE 11 will move to position P2 and the RBS 10 will determine a polarization value E2 of the received signal for the position P2 as well the associated characteristic C2 (“dry”) of the ground surface 12 against which the signal is reflected before the UE 11 moves to position P3 and the RBS 10 will determine a polarization value E3 of the received signal for the position P3 as well the associated characteristic C3 (“wet”) of the ground surface 12 against which the signal is reflected, and so on.

It may further be envisaged that at some other occasion, the UE 11 will again be in position P1 after a rain has occurred. Thus, the RBS 10 will determine a polarization value E4 of the received signal for the position P1 as well the associated characteristic C4 (“wet”) of the ground surface 12 against which the signal is reflected.

Thus, an excerpt from the database (typically containing hundreds or thousands of entries) may have the appearance of Table 2 in the below.

TABLE 2
Example of database surface characteristics.

| Polarization value | Position of UE | Surface characteristic |
|---|---|---|
| E1 | P1 | C1 (dry) |
| E2 | P2 | C2 (dry) |
| E3 | P3 | C3 (wet) |
| E4 | P1 | C4 (wet) |

As a result, when the RBS 10 subsequently receives a signal sent by a UE 10 in position P1 (or close to P1) and the polarization value of the received signal is determined to be E1 (or close to E1), the RBS 10 concludes (cf. step S102) from Table 2 that the current ground surface is dry. To the contrary, should the polarization value of the received signal would have been E4 in position P1, the surface 12 would have been determined to be wet.

In an embodiment, the RBS 10 (or the server 13) may apply machine learning (ML) to observed and recorded data in order to create an ML model from which a surface characteristic may be estimated based on a current position of the UE 11 and a determined polarization value for a received signal. As mentioned, in alternative or addition to determining UE position, the RBS 10 may determine direction-of-arrival of received signals.

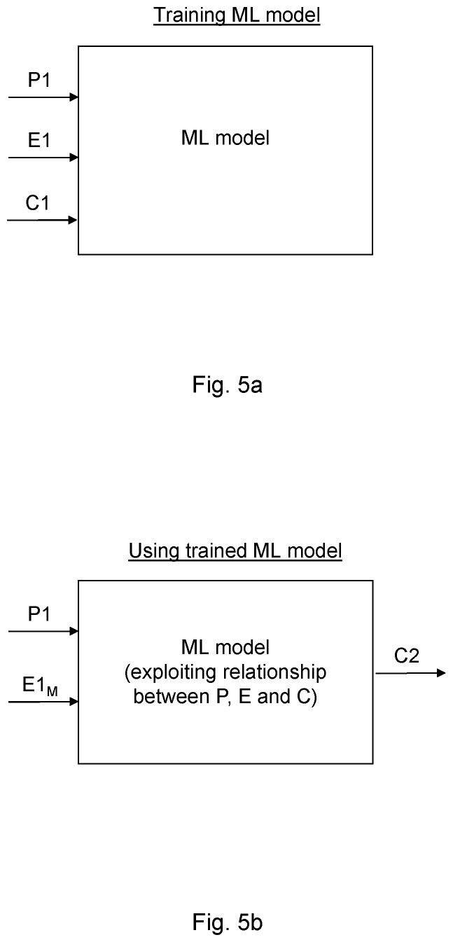

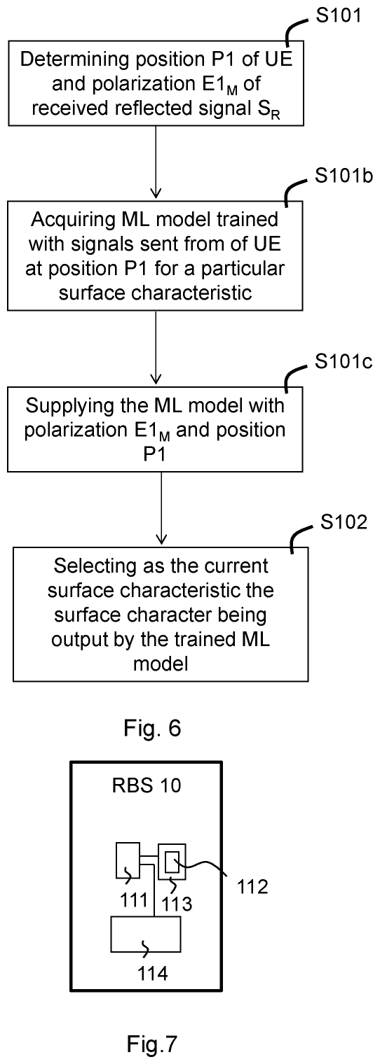

Reference will be made to FIG. 5a illustrating training of an ML model, to FIG. 5b illustrating utilization of the trained ML model to determine the current characteristic of the surface against which a signal S_{R} received at the RBS 10 is reflected, and to FIG. 6 illustrating a flowchart of a method of the RBS 10 of determining a current characteristic of a surface 12 according to an embodiment.

For instance, with reference to FIG. 5a illustrating training of an ML model according to an embodiment, the RBS 10 trains the ML model to conclude that for a given position, say P1, a polarization value of or around E1 is expected for a dry surface (denoted C1) based on reflected signals S_{R} received from the UE 11 when in position P1 and/or for a determined direction-of-arrival of the signal S_{R} at the RBS 10. The UE 11 will typically be instructed to transmit a large number of signals when in position P1 in order to supply the ML model with training material in the form of a great number of observations and hence make the ML model robust. Further, as in FIG. 4, this is typically performed for many different positions in a cell served by the RBS 10. As is understood, the ML model be created and hosted by the server 13 by having the RBS 10 forward any measured signal data to the server 13. The ML model may further identify the UE positions or angle-of-arrival where the difference in received energy is largest for different characteristics.

FIG. 5b illustrates utilizing the trained ML model of FIG. 5a according to an embodiment to determine the current characteristic of the surface against which a signal S_{R} received at the RBS 10 is reflected.

In this exemplifying embodiment, if subsequently a substantially higher polarization value E1_{M} is measured at the RBS 10 for a UE 11 at the same position P1, the RBS 10 will supply P1 and E1_{M} to the trained ML model.

The trained ML model will conclude, based on for instance a known relationship between polarization and characteristic of the surface represented for instance by reflectivity (indirectly by means of the dielectric constant εr of a material) such as the above-discussed Fresnel coefficients, that the current surface no longer is dry but in fact have been exposed to water (indicated in FIG. 5b with surface characteristic C2), since the substantially higher polarization value E1_{M} of the received signal S_{R} indicates a surface 12 having a higher dielectric constant εr and thus a higher reflectivity.

Thus, as can be seen in FIG. 6, similar to FIG. 2, upon the RBS 10 receiving the reflected signal S_{R}, the RBS 10 determines in step S101 one or more energy properties of the received signal S_{R}. In this embodiment, the RBS 10 determines a value E1_{M} representing polarization of the received signal S_{R}. In addition, a current position P1 of the UE 11 is determined.

Thereafter, in step S101b, the trained ML model of FIG. 5a is acquired. As mentioned, this may be trained and stored at the server 13 but may alternatively be trained and stored at the RBS 10.

As described in FIG. 5a, the ML model has been trained with signals received from the UE 11 (exemplified to have polarization values E1) when in position P1, and has further been trained with the characteristic of the surface 12 against which the signal is reflected (exemplified to have characteristic C1).

In step S101c, the measured polarization value E1_{M} of the received signal is supplied to the trained ML model along with the current position P1 of the UE 11.

The ML model will thus estimate, for the position P1 and the polarization value E1_{M}, using a relationship between the polarization and the surface characteristic—for instance the previously described Fresnel coefficients—the surface characteristic corresponding to the polarization value E1_{M}.

As discussed, the measured value E1_{M} is in this example substantially higher than the value E1 used for training the ML model, and the trained ML model will thus conclude that the surface 12 for the current measurement must have a higher reflectivity corresponding to a different type of surface, such as a wet surface.

Finally, in step S102, the current characteristic of the ground surface 12 will be selected to be the surface characteristic being output by the trained ML model.

In addition or in alternative, the RBS 10 may train an ML model to conclude that for a given position, say P3, a polarization value of or around E3 is expected for a wet surface, and if subsequently a substantially lower polarization value E3 M is measured at the RBS 10 for a UE 11 at the same position P3, the RBS 10 will determine that the current surface no longer is wet but in fact have dried up.

It may even be envisaged that if the ML model is sufficiently accurate, the RBS 10 will be capable of determining, from the polarization value of the received signal of a UE 11 at a given position, the dielectric constant εr of the reflecting surface 12 and thus the constitution of the surface (asphalt, water, concrete, etc., see Table 1). Further, it may be envisaged that for a wet surface, further information is associated with the surface characteristics, such as the amount of water on the surface (typically measured in millimetres).

In an embodiment, if the main purpose is the determine whether or not a surface is wet or dry, it is envisaged that if the ML estimates a particular reflectively (i.e. dielectric constant in case the Fresnel coefficients are computed) for a certain signal measurement, two threshold values Tε1 and Tε2 may be utilized.

As can be seen in Table 1, there is a gap in εr between dry surface compositions and wet surface compositions and to avoid any false estimates, a first threshold value Tε1=40 may be set, wherein if the estimated dielectric constant εr>Tε1, the surface 12 is considered wet while if the estimated dielectric constant εr is below a second lower threshold value Tε2=25, the surface 12 is considered dry.

Additional information may be taken into account in the ML model, for instance environmental information e.g. temperature, locality (e.g. Sahara, Brazil, or Alaska) as well as for example calendar information. For instance, detection of rain in Brazil may in the case of Alaska correspond to detection of ice, while in Sahara it may be more interesting to detect send disposed on a surface, which has its own dielectric constant Cr. In the case of sand, different types of sand may be geologically rather different depending on its corresponding bedrock. Thus, sand deployed from a sandstorm originating from one desert area may be distinguished from sand from another desert, and hence depending on location of the cellular systems in respect to said deserts, the solution may further determine origin of the sand and hence the direction of wind.

This ML approach has the advantage that it is not necessary to record different surface characteristics for a given UE position in a database. Rather, the RBS 10 (or server 13) will use the trained model to perform an estimation as to whether the ground surface is wet or dry from recordings associated with one or the other surface type. That is, a dry surface or a wet surface may be used as a “nominal” surface type from which the other type(s) may be estimated.

In an embodiment, it is envisaged that only signals received from certain angles are considered, both during training of the ML model and subsequently when an assessment is to be as regards a current surface characteristic. That is, only signals which are indicated to have been reflected from the ground surface 12 are considered.

A signal S_{R} reflected against the ground surface 12 has a slightly longer path to travel than a direct-path signal SD. Therefore, only signals received within a certain time window after the first arriving (i.e. direct-path) signal SD of a UE 11 are considered. Thus, a signal received from the UE 11 within said certain time window is considered to be a signal S_{R} having been reflected against the ground surface 12.

Advantageously, with this embodiment, other reflections such as e.g. signals reflected against buildings and other objects and multipath reflections are ignored and thus advantageously suppressed.

In a further embodiment, only signals from UEs being in a line-of-sight (LoS) of the RBS 10 are considered, since the ground reflection advantageously is more prominent during LoS conditions.

As is understood, while the wireless communication device from which the RBS 10 receives radio signals is exemplified hereinabove to be a UE 11, signals received over wireless links from any appropriate device may be considered, even non-stationary wireless communication devices.

For instance, such links may for instance be base station to base station communication, e.g. in integrated access-backhaul (IAB) or radio interface based synchronization (RIBS), but also fixed wireless access (FWA) links, or even regular access links where the UE is determined to be stationary.

FIG. 7 illustrates an RBS 10 according to an embodiment, where the steps of the method performed by the RBS 10 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the RBS 10 to carry out the method according to embodiments when the appropriate computer program 112 comprising computer-executable instructions is downloaded to the storage medium 113 and executed by the processing unit in. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The RBS 10 further comprises a communication interface 114 (wired or wireless) over which the RBS 10 is configured to transmit and receive data

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method a radio base station of determining a current characteristic of a surface, the method comprising:
determining a value of at least one energy property of a signal received from a wireless communication device, which signal has reflected against the surface before arriving at the radio base station; and
determining, based on one or more observed signal energy property values each being associated with a characteristic of the surface, the current characteristic of the surface for the determined value of the at least one energy property of the received signal.

2. The method of claim 1, further comprising:
comparing the determined value of the at least one energy property with the one or more observed signal energy property values, each value being associated with a characteristic of the surface; and
the determining of the current characteristic of the surface comprising:
selecting as the current characteristic of the surface the particular characteristic associated with the observed signal energy property value to which the determined value of the at least one energy property is considered to best correspond.

3. The method of claim 2, further comprising:
creating a database comprising the one or more observed signal energy property values by recording at least one signal energy property value and a characteristic of the surface against which the signal is reflected for one or more wireless communication devices one or both of at different positions and for different direction-of-arrivals of the reflected signal being received at the radio base station, wherein the selecting as the current characteristic of the surface comprises:
selecting, from the database, the surface characteristic corresponding to one or both of a current position of the wireless communication device and a current direction-of-arrival of the reflected signal being received at the radio base station, and to the value of the at least one energy property of the signal received for the wireless communication device.

4. The method of claim 1, further comprising:
acquiring a machine learning, ML, model having been trained with observed values of the at least one energy property of signals received from a wireless communication device, a position of the wireless communication device when one or both transmitting each signal and a direction-of-arrival of each reflected signal being received at the radio base station, and the characteristic of the surface against which each signal is reflected;
supplying the determined value of the at least one energy property for the received signal and one or both of a current position of the wireless communication device and a current direction-of-arrival of the reflected signal being received at the radio base station to the acquired trained ML model, the trained ML model estimating for the one or both of the position and direction-of-arrival, using a relationship between the at least one energy property for the received signal and the characteristic of the surface, which surface characteristic the determined value of the at least one energy property energy property represents; and
the determining of the current characteristic of the surface comprising:
selecting as the current characteristic of the surface the surface characteristic being output by the trained ML model.

5. The method of claim 1, wherein a signal being received within a predetermined time period from a firstly received direct-path signal of the wireless communication device is considered to be as signal reflected against the surface before arriving at the radio base station.

6. The method of claim 1, the determined characteristic indicating a reflectivity metric of the surface from which a constitution of the surface can be identified.

7. The method of claim 6, wherein a reflectivity metric exceeding a predetermined first threshold value indicates that the surface is wet, while a reflectivity metric being below a predetermined lower second threshold value indicates that the surface is dry.

8. The method of claim 1, wherein the energy property of the received signal comprises one or more of energy content of the received signal, degree of polarization of the received signal in a horizontal direction, vertical direction, or both, and difference in received energy between two different polarizations.

9. A computer storage medium storing a computer program comprising computer-executable instructions for causing a radio base station to perform steps recited in a method of determining a current characteristic of a surface when the computer-executable instructions are executed on a processing unit included in the radio base station OA), the method comprising:
determining a value of at least one energy property of a signal received from a wireless communication device, which signal has reflected against the surface before arriving at the radio base station; and
determining, based on one or more observed signal energy property values each being associated with a characteristic of the surface, the current characteristic of the surface for the determined value of the at least one energy property of the received signal.

10. (canceled)

11. A radio base station configured to determine a current characteristic of a surface, comprising a processing unit and a memory, the memory containing instructions executable by the processing unit to configure the radio base station to:
determine a value of at least one energy property of a signal received from a wireless communication device, which signal has reflected against the surface before arriving at the radio base station; and
determine, based on one or more observed signal energy property values each being associated with a characteristic of the surface, the current characteristic of the surface for the determined value of the at least one energy property of the received signal.

12. The radio base station of claim 11, further being configured to:
compare the determined value of the at least one energy property with the one or more observed signal energy property values, each value being associated with a characteristic of the surface; and
when determining the current characteristic of the surface:
select as the current characteristic of the surface the particular characteristic associated with the observed signal energy property value to which the determined value of the at least one energy property is considered to best correspond.

13. The radio base station of claim 12, further configured to:
create a database comprising the one or more observed signal energy property values by recording at least one signal energy property value and a characteristic of the surface against which the signal is reflected for one or more wireless communication devices one or both of at different positions and for different direction-of-arrivals of the reflected signal being received at the radio base station; and
when selecting the current characteristic of the surface:
select, from the database, the surface characteristic corresponding to one or both of a current position of the wireless communication device and a current direction-of-arrival of the reflected signal being received at the radio base station, and to the value of the at least one energy property of the signal received for the wireless communication device.

14. The radio base station of claim 11, further configured to:
acquire a machine learning, ML, model having been trained with observed values of the at least one energy property of signals received from a wireless communication device, a position of the wireless communication device when one or both transmitting each signal and a direction-of-arrival of each reflected signal being received at the radio base station, and the characteristic of the surface against which each signal is reflected;
supply the determined value of the at least one energy property for the received signal and one or both of a current position of the wireless communication device and a current direction-of-arrival of the reflected signal being received at the radio base station to the acquired trained ML model, the trained ML model estimating for the one or both of the position and direction-of-arrival, using a relationship between the at least one energy property for the received signal and the characteristic of the surface, which surface characteristic the determined value of the at least one energy property energy property represents; and
when determining the current characteristic of the surface:
select as the current characteristic of the surface the surface characteristic being output by the trained ML model.

15. The radio base station of claim 11, further configured to consider a signal being received within a predetermined time period from a firstly received direct-path signal of the wireless communication device as a signal reflected against the surface before arriving at the radio base station.

16. The radio base station of claim 11, the determined characteristic being configured to indicate a reflectivity metric of the surface from which a constitution of the surface can be identified.

17. The radio base station of claim 16, wherein a reflectivity metric exceeding a predetermined first threshold value is configured to indicate that the surface is wet, while a reflectivity metric being below a predetermined lower second threshold value indicates that the surface is dry.

18. The radio base station of claim 11, wherein the energy property of the received signal comprises one or more of energy content of the received signal, degree of polarization of the received signal in a horizontal direction, vertical direction, or both, and difference in received energy between two different polarizations.

19. The method of claim 2, wherein a signal being received within a predetermined time period from a firstly received direct-path signal of the wireless communication device is considered to be as signal reflected against the surface before arriving at the radio base station.

20. The method of claim 2, the determined characteristic indicating a reflectivity metric of the surface from which a constitution of the surface can be identified.

21. The method of claim 2, wherein the energy property of the received signal comprises one or more of energy content of the received signal, degree of polarization of the received signal in a horizontal direction, vertical direction, or both, and difference in received energy between two different polarizations.
